(19) United States
(12) Patent Application Publication
(10) Pub. No.: US 2025/0184060 A1
(43) Pub. Date: Jun. 5, 2025

(54) TERMINAL, RADIO COMMUNICATION METHOD, AND BASE STATION

(71) Applicant: NTT DOCOMO, INC., Tokyo (JP)

(72) Inventors: Naoya Shibaike, Tokyo (JP); Yuki Matsumura, Tokyo (JP); Satoshi Nagata, Tokyo (JP)

(73) Assignee: NTT DOCOMO, INC., Tokyo (JP)

(21) Appl. No.: 18/837,786

(22) PCT Filed: Feb. 14, 2022
(86) PCT No.: PCT/JP2022/005711

§ 371 Date: Aug. 12, 2024

(51) Int. Cl. H04L 5/00; H04B 7/06

(52) U.S. Cl. CPC H04L 5/0048; H04B 7/0602

(57) ABSTRACT

A terminal according to one aspect of the present disclosure includes a transmitting section that transmits one or more capability information elements indicating support of a first configuration in which y antennas and x antenna ports are used for sounding reference signal (SRS) transmission, and support of a second configuration in which a part of y antennas and x antenna ports are used for the SRS transmission, and a control section that controls the SRS transmission, based on a configuration depending on the capability information. y is 6 or more, and x is y or less. According to one aspect of the present disclosure, it is possible to appropriately report a capability related to an SRS.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+(plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

In invitation radio communication systems, a sounding reference signal (SRS) is used for various purposes. For example, an SRS in NR is used not only for uplink (UL) CSI measurement, but also for downlink (DL) CSI measurement, beam management, and the like.

It is studied that a terminal uses more antennas.

However, progress has not been made on a study of reporting of a capability of the terminal using more antennas. Unless a method for such reporting is definite, communication throughput/communication quality and the like may deteriorate.

Thus, an object of the present disclosure is to provide a terminal, a radio communication method, and a base station that appropriately report a capability related to an SRS.

### Solution to Problem

A terminal according to one aspect of the present disclosure includes a transmitting section that transmits one or more capability information elements indicating support of a first configuration in which y antennas and x antenna ports are used for sounding reference signal (SRS) transmission, and support of a second configuration in which a part of y antennas and x antenna ports are used for the SRS transmission, and a control section that controls the SRS transmission, based on a configuration depending on the capability information. y is 6 or more, and x is y or less.

### Advantageous Effects of Invention

According to one aspect of the present disclosure, it is possible to appropriately report a capability related to an SRS.

### BRIEF DESCRIPTION OF DRAWINGS

FIG. 1 shows an example of existing SRS antenna switching configuration.

FIG. 2 shows an example of SRS antenna switching configuration according to variation #0.

FIG. 3 shows an example of SRS antenna switching configuration according to variation #2.

FIG. 4 is a diagram to show an example of a schematic structure of a radio communication system according to one embodiment.

FIG. 5 is a diagram to show an example of a structure of a base station according to one embodiment.

FIG. 6 is a diagram to show an example of a structure of a user terminal according to one embodiment.

FIG. 7 is a diagram to show an example of a hardware structure of the base station and the user terminal according to one embodiment.

FIG. 8 is a diagram to show an example of a vehicle according to one embodiment.

### DESCRIPTION OF EMBODIMENTS

### (SRS)

In NR, a sounding reference signal (SRS) is used for various purposes. The SRS in NR is used not only for uplink (UL) CSI measurement also used in existing LTE (LTE Rel. 8 to 14), but also for downlink (DL) CSI measurement, beam management, and the like.

A UE may be configured with one or a plurality of SRS resources. The SRS resource(s) may be identified by an SRS resource index (SRI).

Each SRS resource may have one or a plurality of SRS ports (may correspond to one or a plurality of SRS ports). For example, the number of ports for each SRS may be 1, 2, 4, or the like.

The UE may be configured with one or a plurality of SRS resource sets. One SRS resource set may be associated with a certain number of SRS resources. The UE may use a higher layer parameter in common for SRS resources included in one SRS resource set. Note that a resource set in the present disclosure may be interpreted as a set, a resource group, a group, or the like.

Information related to an SRS resource or a resource set may be configured for the UE by using higher layer signaling, physical layer signaling, or a combination of these.

An SRS configuration information element (for example, an RRC information element “SRS-Config”) may include an SRS resource set configuration information element, an SRS resource configuration information element, and the like.

The SRS resource set configuration information element (for example, an RRC parameter “SRS-ResourceSet”) may include an SRS resource set ID (Identifier) (SRS-ResourceSetId), a list of SRS resource IDs (SRS-ResourceId) used in the resource set, an SRS resource type (resourceType), and information about SRS usage.

Here, the SRS resource type may indicate time domain behavior for SRS resource configuration (same time domain behavior), and may indicate any one of a periodic SRS (P-SRS), a semi-persistent SRS (SP-SRS), and an aperiodic SRS (A-SRS). Note that the UE may periodically (or, after activation, periodically) transmit the P-SRS and the SP-SRS. The UE may transmit the A-SRS, based on an SRS request of the DCI.

The SRS usage (an RRC parameter “usage” or an L1 (Layer-1) parameter “SRS-SetUse”) may be, for example, beam management (beamManagement), codebook (CB), non-codebook (NCB), antenna switching (antennaSwitcing), or the like. For example, an SRS for codebook or non-codebook usage may be used for determination of a precoder for codebook-based or non-codebook-based uplink shared channel (Physical Uplink Shared Channel (PUSCH)) transmission based on the SRI.

For an SRS for beam management usage, it may be assumed that only one SRS resource can be transmitted for each SRS resource set in a certain time instant (given time instant). Note that when a plurality of SRS resources corresponding to the same time domain behavior belong to different SRS resource sets in the same Bandwidth Part (BWP), these SRS resources may be transmitted simultaneously.

The SRS resource configuration information element (for example, an RRC parameter “SRS-Resource”) may include an SRS resource ID (SRS-ResourceId), the number of SRS ports, an SRS port number, the number of transmission combs, SRS resource mapping (for example, a time and/or frequency resource position, resource offset, a resource periodicity, the number of repetitions, the number of SRS symbols, an SRS bandwidth, or the like), hopping-related information, an SRS resource type, a sequence ID, spatial relation information, and the like.

Values of the number of transmission combs (transmissionComb) are {2, 4}. Values of the number Nₐₚ^{SRS} of antenna ports (nrofSRS-Ports) are {1, 2, 4}. Values of antenna port number pᵢ are {1000, 1001, . . . }. Values of the number N_{symb}^{SRS} of consecutive SRS OFDM symbols (nrofSymbols) are {1, 2, 4}. For a start position (startPosition) in a time domain, symbol offset l_{offset} counted from an end of a slot in a direction opposite to the time domain is {0, 1, . . . 5}, and the start position is given by l₀=N_{symb}^{slot}−1−l_{offset}.

Configuration of the number of transmission combs may include comb offset and cyclic shift (cyclic shift (CS) index, CS number).

SRSs from the UE with at least one of different comb offsets (subcarrier offsets)={0, 1, . . . K_{TC}−1} and different CSs may be multiplexed with each other by using the same number of transmission combs, the same RB, and the same symbol.

For each slot, the UE may switch a Bandwidth Part (BWP) for transmitting an SRS, or may switch an antenna. The UE may apply, to SRS transmission, at least one of intra-slot hopping and inter-slot hopping.

In an existing SRS, frequency domain start position k₀^{p_i} for pᵢ (p_i) is given by the following equation.

$${k}_{0}^{p \_ i} = {k}_{0}^{- p \_ i} + {Σ}_{b = 0}^{BSRS} {K}_{TC} {M}_{SC} , {b}^{SRS} {n}_{b}$$

Here, k⁻ indicates a variable obtained by adding an overline to k, and may also be referred to as k bar. k⁻₀^{p_i} may be based on comb offset. K_{TC} is the number of transmission combs. M_{SC,b}^{SRS} is the number of subcarriers in SRS bandwidth m_{SRS,b} [RB], the subcarriers being used for SRS transmission. n_{b} is a constant.

### (UE Sounding/Antenna Switching for DL CSI Acquisition)

When the UE is configured by using an SRS resource set (SRS-ResourceSet), and usage (higher layer parameter “usage”) in the SRS resource set is set to antenna switching (‘antennaSwitching’), the UE does not assume that different spatial relations are configured for a plurality of SRS resources in the same SRS resource set.

When the UE is configured by using an SRS resource set (SRS-ResourceSet), and usage (higher layer parameter “usage”) in the SRS resource set is set to antenna switching (‘antennaSwitching’), the UE may be configured with one of configuration 1 to configuration 5 below, depending on indicated (reported) UE capability information (UE antenna switching capability information, which may be performed, UE capability information indicating an SRS transmission port switching pattern (SRS antenna switching configuration) supported by the UE, supportedSRS-TxPortSwitch).

UE capability information for SRS transmission switch (srs-TxSwitch) indicates whether an SRS for DL CSI acquisition (DL CSI obtainment, transmission antenna switching, SRS antenna switching) is supported. The UE capability information includes a parameter “supportedSRS-TxPortSwitch.” “supportedSRS-TxPortSwitch” indicates an SRS transmission (Tx) port switching pattern supported by the UE. The SRS transmission port switching pattern is a mandatory function with capability signaling.

A value of “supportedSRS-TxPortSwitch” may indicate ‘t1r2,’ ‘t2r4,’ ‘t1r4,’ ‘t1r4-t2r4,’ ‘t1r1,’ ‘t2r2,’ ‘t4r4,’ and ‘notsupported’ for 1T2R, 2T4R, 1T4R, 1T4R/2T4R, 1T=1R, 2T=2R, 4T=4R, and non-support, respectively.

A UE antenna switching capability for which xTyR (‘txry’) is indicated by “supportedSRS-TxPortSwitch” corresponds to the UE capable of performing SRS transmission on x antenna ports over a total of y antennas. y corresponds to all or subset of UE reception antennas. For example, 2T4R corresponds to two pairs of antennas.

### {Configuration 1}

For 1T2R, up to two SRS resource sets configured with different values for a resource type (higher layer parameter “resourceType”) in the SRS resource set. Each set has two SRS resources transmitted in different symbols, each SRS resource in a given set comprises a single SRS port, and an SRS port for a second resource in the set is associated with a UE antenna port different from an SRS port for a first resource in the same set.

### {Configuration 2}

For 2T4R, up to two SRS resource sets configured with different values for a resource type (higher layer parameter “resourceType”) in the SRS resource set. Each SRS resource set has two SRS resources transmitted in different symbols, each SRS resource in a given set comprises two SRS ports, and an SRS port pair for a second resource in the set is associated with a UE antenna port pair different from an SRS port pair for a first resource in the same set.

### {Configuration 3}

For 1T4R, zero or one SRS resource set configured with a resource type (higher layer parameter “resourceType”) in an SRS resource set having four SRS resources transmitted in different symbols, the SRS resource set being set to “periodic” or “semi-persistent.” Each SRS resource in a given set comprises a single SRS port, and an SRS port for each resource is associated with a different UE antenna port.

### {Configuration 4}

For 1T4R, zero or two SRS resource sets configured with respective resource types (higher layer parameters “resourceType”) in SRS resource sets having a total of four SRS resources transmitted in different symbols of two different slots, the SRS resource sets being set to “aperiodic.” An SRS port for each SRS resource in two given sets is associated with a different UE antenna port. Each of the two sets is configured with two SRS resources, or one of the two sets is configured with one SRS resource, and the other is configured with three SRS resources. The UE assumes (expects) that both of the two sets are configured with the same value of a power control parameter (higher layer parameters “alpha,” “p0,” “pathlossReferenceRS,” and “srs-PowerControlAdjustmentStates”) in the SRS resource set. The UE assumes that values of parameters (higher layer parameters “aperiodicSRS-ResourceTrigger,” parameters indicating codepoints of SRS request fields in DCI) in respective SRS resource sets are the same and that values of higher layer parameters “slotOffset” in the respective SRS resource sets are different from each other.

### {Configuration 5}

For 1T=1R, 2T=2R, or 4T=4R, up to two SRS resources sets each having one SRS resource. The number of SRS ports for each resource is 1, 2, or 4.

When usage in the SRS resource set is set to antenna switching for the UE, the UE may be configured with an SRS antenna switching configuration, depending on reported UE capability information (supportedSRS-TxPortSwitch, supportedSRS-TxPortSwitch-v1610).

When an SRS resource of a certain set is transmitted in the same slot as that for Y symbol(s), the UE is configured with a guard period of Y symbol(s) in which the UE does not transmit any other symbol. The guard period is present between SRS resources of the set.

If an indicated UE capability is 1T4R/2T4R, the UE assumes that the same number of SRS ports being 1 or 2 is configured for all the SRS resources in the SRS resource set.

If an indicated UE capability is 1T2R, 2T4R, 1T4R, or 1T4R/2T4R, the UE does not assume that more than one SRS resource set having usage (higher layer parameter “usage”) set to antenna switching is configured or triggered in the same slot. If an indicated UE capability is 1T1R, 2T2R, or 4T4R, the UE does not assume that more than one SRS resource set having usage (higher layer parameter “usage”) set to antenna switching is configured or triggered in the same symbol.

UE capability information for SRS transmission switch (srs-TxSwitch-v1610) may include a parameter “supportedSRS-TxPortSwitch-v1610.” “supportedSRS-TxPortSwitch-v1610” indicates downgrading configuration of an SRS transmission port switching pattern, and reporting thereof is optional. When indicating support of downgrading configuration of the SRS transmission port switching pattern by using “supportedSRS-TxPortSwitch-v1610,” the UE may report at least one of the following values for indicating support of the downgrading configuration, based on information reported in “supportedSRS-TxPortSwitch.”
‘t1r1-t1r2’
‘t1r1-t1r2-t1r4’
‘t1r1-t1r2-t2r2-t2r4’
‘t1r1-t2r2’
‘t1r1-t2r2-t4r4’
‘t1r1-t1r2-t2r2-t1r4-t2r4’

### (Analysis)

An existing NR specification supports SRS switching for up to four antennas. For Rel. 17, it is studied that SRS switching for up to eight antennas is supported. For example, it is studied that xTyR, x={1, 2, 4}, and y={6, 8} are supported.

In Rel. 17, SRS antenna switching configuration below is supported. K may be a total number (sum) of SRS resources. N may be the number of SRS resource sets. N_max may N may be a maximum number of SRS resource sets.
For 1T6R, K=6, N_max=3 (N=1, 2, 3), and each SRS resource may have 1 port.
For 1T8R, K=8, N_max=4 (N=2, 3, 4), and each SRS resource may have 1 port.
For 2T6R, K=3, N_max=3 (N=1, 2, 3), and each SRS resource may have 2 ports.
For 2T8R, K=4, N_max=4 (N=1, 2, 3, 4), and each SRS resource may have 2 ports.
For 4T8R, K=2, N_max=2 (N=1, 2), and each SRS resource may have 4 ports.

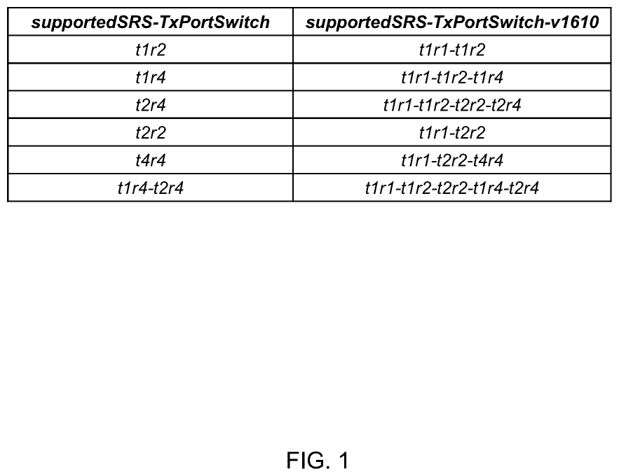

A Rel-15 UE can support only an SRS antenna switching configuration of supportedSRS-TxPortSwitch from among SRS antenna switching configurations in FIG. 1. In other words, the UE supports only an SRS antenna switching configuration for performing sounding for DL CSI acquisition by using all the implemented reception (Rx) antennas. In the present disclosure, this configuration may be referred to as a mandatory configuration.

A Rel-16 UE can support a pattern of supportedSRS-TxPortSwitch-v1610 in addition to a pattern of supportedSRS-TxPortSwitch from among SRS transmission port switching patterns (patterns) in FIG. 1. In other words, the UE can support an SRS antenna switching configuration (for example, supportedSRS-TxPortSwitch-v1610) for performing sounding for DL CSI acquisition by using only reception antenna(s) less than the number of implemented reception antennas. In the present disclosure, this SRS antenna switching configuration/pattern may be referred to as a downgrading (downgraded) configuration.

The following configurations from among the patterns in FIG. 1 are mandatory configurations.
‘t1r2’ for 1T2R
‘t2r4’ for 2T4R
‘t1r4’ for 1T4R
‘t1r1’ for 1T=1R
‘t2r2’ for 2T=2R
‘t4r4’ for 4T=4R

The following configurations from among the patterns in FIG. 1 are downgrading configurations.
‘t1r1-t1r2’ for 1T=1R/1T2R
‘t1r1-t1r2-t1r4’ for 1T=1R/1T2R/1T4R
‘t1r4-t2r4’ for 1T4R/2T4R
‘t1r1-t1r2-t2r2-t2r4’ for 1T=1R/1T2R/2T=2R/2T4R
‘t1r1-t1r2-t2r2-t1r4-t2r4’ for 1T=1R/1T2R/2T=2R/1T4R/2T4R
‘t1r1-t2r2’ for 1T=1R/2T=2R
‘t1r1-t2r2-t4r4’ for 1T=1R/2T=2R/4T=4R

For example, when the UE has reported ‘t1r1-t1r2,’ an antenna with 1T2R is implemented, but an SRS antenna switching configuration using only 1T1R can be configured.

However, how to enhance an SRS antenna switching configuration/pattern is indefinite. For example, a case where the number of Rxs (y) is 6/8 includes an issue related to whether a downgrading configuration is supported and how a mandatory configuration/downgrading configuration is configured. For example, the case includes an issue related to whether reporting of whether to support the mandatory configuration/downgrading configuration is defined as a single piece of capability information or a plurality of pieces of capability information. For example, a case where the downgrading configuration is supported includes an issue related to whether all the patterns conceivable as the downgrading configuration are supported, whether only a part of the patterns are supported, and whether a supported pattern is variable.

Unless such capability reporting/configuration for an SRS is definite, communication throughput/communication quality and the like may deteriorate.

Thus, the inventors of the present invention came up with the idea of a method for capability reporting/configuration for an SRS.

Embodiments according to the present disclosure will be described in detail with reference to the drawings as follows.

The radio communication methods according to respective embodiments may each be employed individually, or may be employed in combination.

In the present disclosure, “A/B” and “at least one of A and B” may be interchangeably interpreted. In the present disclosure, “A/B/C” may mean “at least one of A, B, and C.”

In the present disclosure, activate, deactivate, indicate, select, configure, update, determine, and the like may be interchangeably interpreted. In the present disclosure, “support,” “control,” “controllable,” “operate,” “operable,” and the like may be interchangeably interpreted.

In the present disclosure, radio resource control (RRC), an RRC parameter, an RRC message, a higher layer parameter, an information element (IE), a configuration, and the like may be interchangeably interpreted. In the present disclosure, a Medium Access Control control element (MAC Control Element (CE)), an update command, an activation/deactivation command, and the like may be interchangeably interpreted.

In the present disclosure, the higher layer signaling may be, for example, any one or combinations of Radio Resource Control (RRC) signaling, Medium Access Control (MAC) signaling, broadcast information, and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, the physical layer signaling may be, for example, downlink control information (DCI), uplink control information (UCI), or the like.

In the present disclosure, an index, an identifier (ID), an indicator, a resource ID, and the like may be interchangeably interpreted. In the present disclosure, a sequence, a list, a set, a group, a cluster, a subset, and the like may be interchangeably interpreted.

### (Radio Communication Method)

In each embodiment, a Rel-17 SRS, a new SRS, and a new SRS antenna switching may be interchangeably interpreted.

In each embodiment, a configuration, an SRS antenna switching configuration, and an SRS transmission port switching pattern may be interchangeably interpreted. In each embodiment, an SRS transmission port switching pattern, a pattern, and a combination of one or more supported SRS antenna switching configurations may be interchangeably interpreted.

In each embodiment, an antenna structure, antenna implementation, antenna architecture, and the number of antennas may be interchangeably interpreted.

In each embodiment, an antenna port, a transmission antenna port, an antenna port used for SRS transmission, and an antenna port used for SRS antenna switching may be interchangeably interpreted. In each embodiment, an antenna, a receive antenna, and a UE reception antenna may be interchangeably interpreted.

In each embodiment, x, the number of Txs, the number of antenna ports, the number of transmission antenna ports, and the number of antenna ports used for SRS transmission may be interchangeably interpreted. In each embodiment, y, the number of Rxs, the number of antennas, the number of reception antennas, and the number of antennas used for SRS transmission may be interchangeably interpreted.

In each embodiment, a function (feature) group (FG) and UE capability information for SRS transmission switching may be interchangeably interpreted.

### First Embodiment

This embodiment relates to UE capability reporting.

In UE capability reporting related to a Rel-17 SRS, a UE capability related to SRS antenna switching for DL CSI acquisition may follow either choice 1 or choice 2 below.

### {Choice 1}

A single function group (feature group, FG) is defined, and a UE reports the single FG. This single FG may be capable of reporting support of at least one of a mandatory configuration and a downgrading configuration. This single FG may be SRS transmission switching (SRS Tx switch). This single FG may include a supported SRS transmission switching pattern (supportedSRS-TxPortSwitch), whether the UL transmission switching affects DL reception in a band (band in which the UL transmission has an impact on DL, txSwitchImpactToRx), and whether the UL transmission is switched together with UL transmission in another band (band in which all the ULs and DLs are switched together, txSwitchWithAnotherBand).

### {Choice 2}

A plurality of FGs are defined, and the UE reports the plurality of FGs. These plurality of FGs may include a first FG for reporting support of a mandatory configuration and a second FG for reporting support of a downgrading configuration. A first FG for reporting support of a mandatory configuration may be defined, and the first FG may be a prerequisite FG of a second FG for reporting support of a downgrading configuration. In other words, reporting of support of the downgrading configuration (second FG) may require reporting of support of the mandatory configuration (first FG). The first FG may be SRS transmission switching (SRS Tx switch). The second FG may be SRS transmission switching allowing a downgrading configuration (SRS Tx switch with down grading configuration). The first FG may include supportedSRS-TxPortSwitch, txSwitchImpactToRx, and txSwitchWithAnotherBand. The second FG may include a supported SRS transmission switching pattern for a downgrading configuration (supportedSRS-TxPortSwitch-x), and may not include txSwitchImpactToRx and txSwitchWithAnotherBand.

According to this embodiment, the UE can appropriately report a UE capability related to SRS antenna switching configuration.

### Second Embodiment

This embodiment relates to UE capability reporting for downgrading configuration.

In UE capability reporting related to a Rel-17 SRS, reporting of a UE capability/pattern related to downgrading configuration, from among UE capabilities related to SRS antenna switching for DL CSI acquisition, may follow either choice 1 or choice 2 below.

### {Choice 1}

A UE collectively reports support of all the downgrading configurations capable of being achieved by an antenna structure implemented for the UE.

### {Choice 2}

The UE reports support of only a part of the downgrading configurations capable of being achieved by the antenna structure implemented for the UE.

Here, the antenna structure may be either option 1 or option 2 below.

### {Option 1}

The antenna structure may indicate the number of antennas (number of transmission antennas/number of reception antennas) based on x (number of Txs)/y (number of Rxs) reported as a mandatory configuration.

### {Option 2}

The antenna structure may indicate x (number of Txs)/y (number of Rxs) based on a maximum number of x (number of Txs)/y (number of Rxs), from among configurations reported as supported configurations.

Here, the “downgrading configurations capable of being achieved by the antenna structure implemented for the UE” may indicate an SRS antenna switching configuration (pattern) using x (number of Txs)/y (number of Rxs) equal to or less than x (number of Txs)/y (number of Rxs) in the antenna structure.

According to this embodiment, the UE can appropriately report a UE capability related to SRS antenna switching configuration.

### Third Embodiment

This embodiment relates to a combination/variation of the first and second embodiments.

### <<Variation #0>>

The UE may report all or a part of the following SRS antenna switching configurations by using only one FG for antenna switching.
Only supported mandatory configuration
Supported mandatory configuration, supported and downgrading configuration

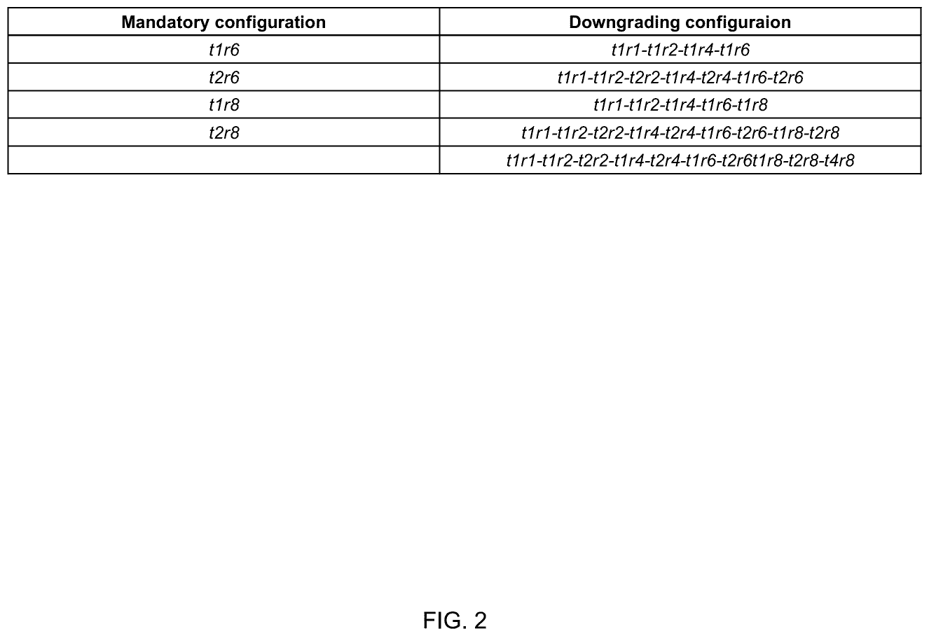

Candidates for a value of a UE capability/pattern to be reported may include any one of the following (FIG. 2).
Mandatory configuration:
   ‘t1r6’ for 1T6R
   ‘t2r6’ for 2T6R
   ‘t1r8’ for 1T8R
   ‘t2r8’ for 2T8R
Downgrading configuration:
   ‘t1r1-t1r2-t1r4-t1r6’ for 1T=1R/1T2R/1T4R/1T6R
   ‘t1r1-t1r2-t2r2-t1r4-t2r4-t1r6-t2r6’ for 1T=1R/1T2R/2T=2R/1T4R/2T4R/1T6R/2T6R
   ‘t1r1-t1r2-t1r4-t1r6-t1r8’ for 1T=1R/1T2R/1T4R/1T6R/1T8R
   ‘t1r1-t1r2-t2r2-t1r4-t2r4-t1r6-t2r6-t1r8-t2r8’ for 1T=1R/1T2R/2T=2R/1T4R/2T4R/1T6R/2T6R/1T8R/2T8R
   ‘t1r1-t1r2-t2r2-t1r4-t2r4-t1r6-t2r6t1r8-t2r8-t4r8’ for 1T=1R/1T2R/2T=2R/1T4R/2T4R/1T6R/2T6R1T8R/2T8R/4T8R

### <<Variation #1>>

The UE may report at least one of the following SRS antenna switching configurations by using only one FG for antenna switching.
One or plurality of SRS antenna switching configurations (patterns)
One or plurality of SRS antenna switching configurations (patterns) freely selected from mandatory configuration(s) and downgrading configuration(s) For example, one or more SRS antenna switching configurations from among {t1r1, t2r2, t1r2, t4r4, t2r4, t1r4, t2r6, t1r6, t4r8, t2r8, t1r8}.
Combination (pattern) of one or plurality of mandatory configurations and x downgrading configurations associated with that mandatory configuration(s) For example, such a combination as {t2r6, t1r8} is not reported.

### <<Variation #2>>

In variation #0, SRS antenna switching configuration may be added.

The UE may report all or a part of the following SRS antenna switching configurations by using only one FG for antenna switching.
Only supported mandatory configuration
Supported mandatory configuration and supported downgrading configuration
Supporting SRS antenna switching configuration with y=6 (6R) when SRS antenna switching configuration with y=8 (8R) is supported, or not supporting SRS antenna switching configuration with y=6 (6R) when SRS antenna switching configuration with y=8 (8R) is supported

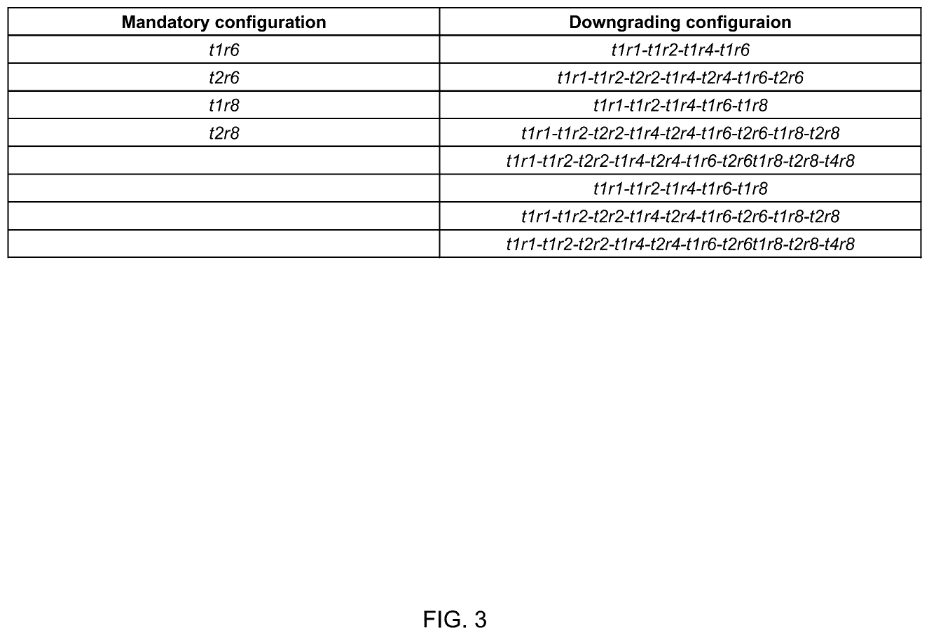

Candidates for a value of a UE capability/pattern to be reported may include any one of the following (FIG. 3).
Mandatory configuration:
‘t1r6’ for 1T6R
‘t2r6’ for 2T6R
‘t1r8’ for 1T8R
‘t2r8’ for 2T8R
Downgrading configuration:
   ‘t1r1-t1r2-t1r4-t1r6’ for 1T=1R/1T2R/1T4R/1T6R
   ‘t1r1-t1r2-t2r2-t1r4-t2r4-t1r6-t2r6’ for 1T=1R/1T2R/2T=2R/1T4R/2T4R/1T6R/2T6R
   ‘t1r1-t1r2-t1r4-t1r6-t1r8’ for 1T=1R/1T2R/1T4R/1T6R/1T8R
   ‘t1r1-t1r2-t2r2-t1r4-t2r4-t1r6-t2r6-t1r8-t2r8’ for 1T=1R/1T2R/2T=2R/1T4R/2T4R/1T6R/2T6R/1T8R/2T8R
   ‘t1r1-t1r2-t2r2-t1r4-t2r4-t1r6-t2r6t1r8-t2r8-t4r8’ for 1T=1R/1T2R/2T=2R/1T4R/2T4R/1T6R/2T6R1T8R/2T8R/4T8R
   ‘t1r1-t1r2-t2r2-t1r4-t2r4-t1r8-t2r8’ for 1T=1R/1T2R/2T=2R/1T4R/2T4R/1T8R/2T8R
   ‘t1r1-t1r2-t2r2-t1r4-t2r4-t1r8-t2r8-t4r8’ for 1T=1R/1T2R/2T=2R/1T4R/2T4R/1T8R/2T8R/4T8R

### <<Variation #3>>

The UE may report a first FG for antenna switching and a second FG for reporting of support of a downgrading configuration.

The first FG may report antenna implementation/antenna structure. For example, candidates for a value of a UE capability/pattern indicating antenna implementation may include any one of the following.
‘t1r6’ for 1T6R
‘t2r6’ for 2T6R
‘t1r8’ for 1T8R
‘t2r8’ for 2T8R

The second FG may include a supported downgrading configuration, based on antenna implementation/antenna structure. When a downgrading configuration based on antenna implementation is not supported, the second FG may not be reported. For example, candidates for a value of a UE capability/pattern corresponding to the second FG may include at least one of {t1r1, t2r2, t1r2, t4r4, t2r4, t1r4, t2r6, t1r6, t4r8, t2r8, t1r8}. A Tx value/Rx value of SRS antenna switching configuration reported in the second FG may be less than a Tx value/Rx value of SRS antenna switching configuration reported in the first FG.

According to this embodiment, the UE can appropriately report a UE capability related to SRS antenna switching configuration.

### Other Embodiments

### <<UE Capability Information/Higher Layer Parameter>>

A higher layer parameter (RRC IE)/UE capability corresponding to a function (characteristics, feature) in each embodiment above may be defined. The higher layer parameter may indicate whether the function is enabled. The UE capability may indicate whether the UE supports the function.

The UE configured with the higher layer parameter corresponding to the function may perform the function. “The UE not configured with the higher layer parameter corresponding to the function does not perform the function (for example, follows Rel. 15/16)” may be defined.

The UE that has reported/transmitted the UE capability indicating support of the function may perform the function. “The UE that has not reported the UE capability indicating support of the function does not perform the function (for example, follows Rel. 15/16)” may be defined.

When the UE reports/transmits the UE capability indicating support of the function and is configured with the higher layer parameter corresponding to the function, the UE may perform the function. “When the UE does not report/transmit the UE capability indicating support of the function or when the UE is not configured with the higher layer parameter corresponding to the function, the UE does not perform the function (for example, follows Rel. 15/16)” may be defined.

Which embodiment/option/variation/choice/function in the plurality of embodiments above is used may be configured by a higher layer parameter, may be reported by a UE as a UE capability, may be defined in a specification, or may be determined by a reported UE capability and higher layer parameter configuration.

The UE capability/higher layer parameter may indicate a function of a UE capability in each embodiment.

According to the UE capability/higher layer parameter above, the UE can implement the above functions while maintaining compatibility with an existing specification.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

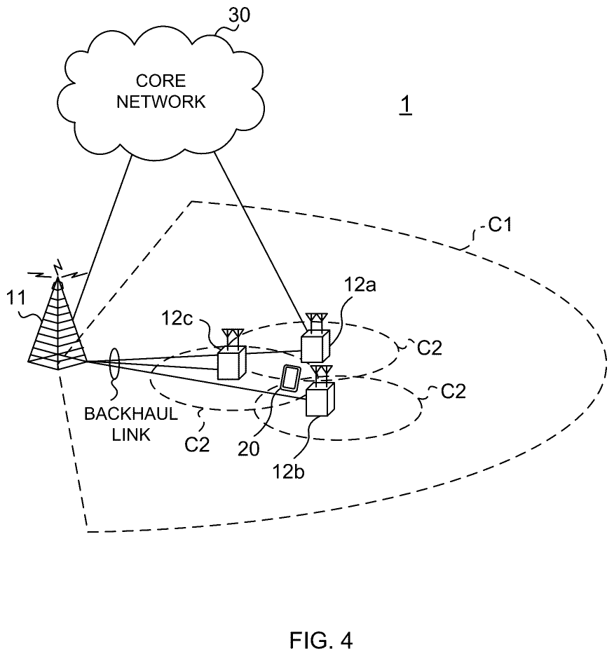

FIG. 4 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2. The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information, and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data,” and the PUSCH may be interpreted as “UL data.”

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

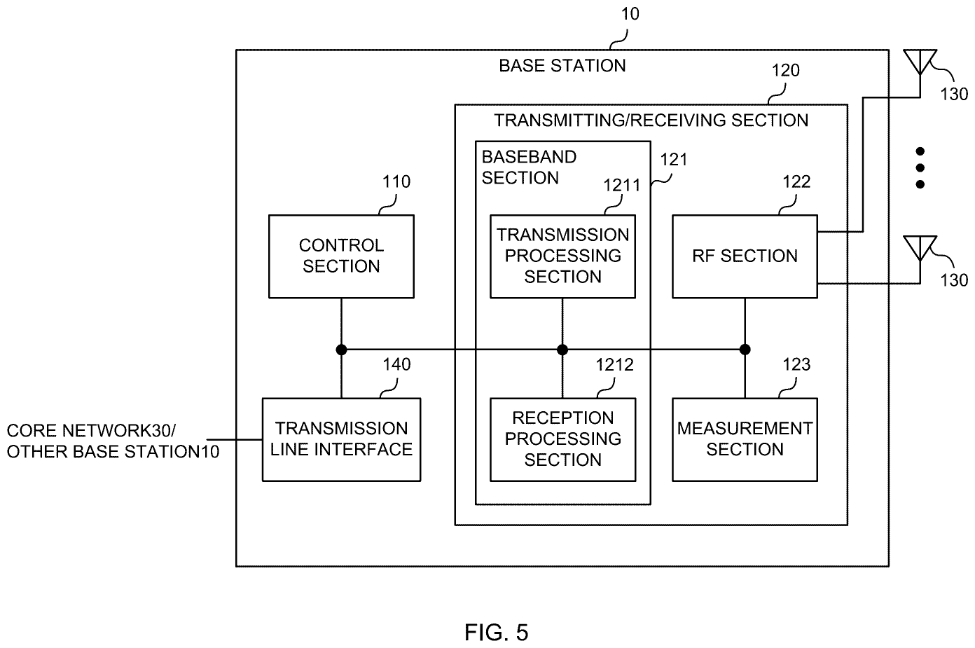

FIG. 5 is a diagram to show an example of a structure of the base station according to one embodiment. The base station 10 includes a control section 110, a transmitting/receiving section 120, transmitting/receiving antennas 130 and a transmission line interface 140. Note that the base station 10 may include one or more control sections 110, one or more transmitting/receiving sections 120, one or more transmitting/receiving antennas 130, and one or more transmission line interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the transmission line interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The transmission line interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the transmission line interface 140.

The transmitting/receiving section 120 may receive one or more capability information elements indicating support of a first configuration in which a terminal uses y antennas and x antenna ports for sounding reference signal (SRS) transmission, and support of a second configuration in which the terminal uses a part of y antennas and x antenna ports for the SRS transmission. The control section 110 may control the SRS transmission, based on a configuration depending on the capability information. y may be 6 or more, and x may be y or less.

### (User Terminal)

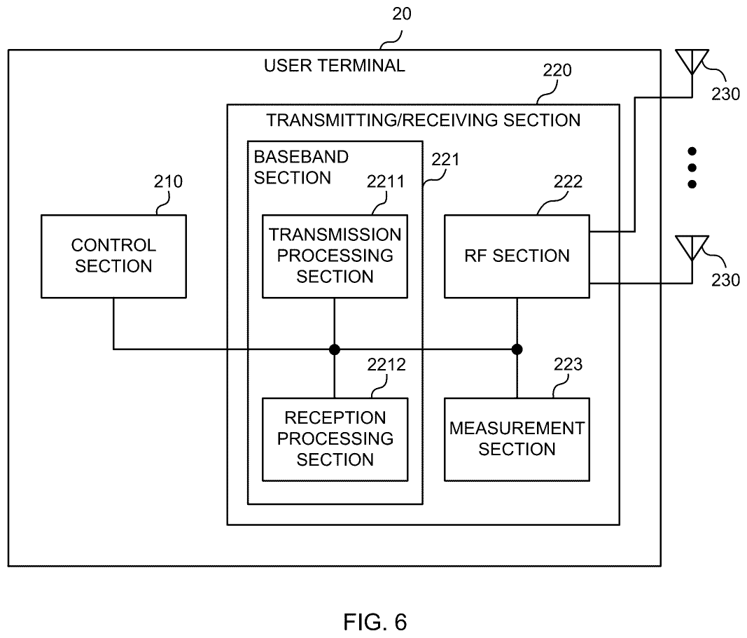

FIG. 6 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure received power (for example, RSRP), received quality (for example, RSRQ, SINR, SNR), signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

The transmitting/receiving section 220 may transmit one or more capability information elements indicating support of a first configuration in which y antennas and x antenna ports are used for sounding reference signal (SRS) transmission, and support of a second configuration in which a part of y antennas and x antenna ports are used for the SRS transmission. The control section 210 may control the SRS transmission, based on a configuration depending on the capability information. y may be 6 or more, and x may be y or less.

The one or more capability information elements may correspond to one function group, and may indicate support of the first configuration and the second configuration.

The one or more capability information elements may include a first capability information element corresponding to a first function group and indicating support of the first configuration, and a second capability information element corresponding to a second function group and indicating support of the second configuration.

The one or more capability information elements may indicate support of all or a part of a plurality of the second configurations capable of being used by y antennas.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

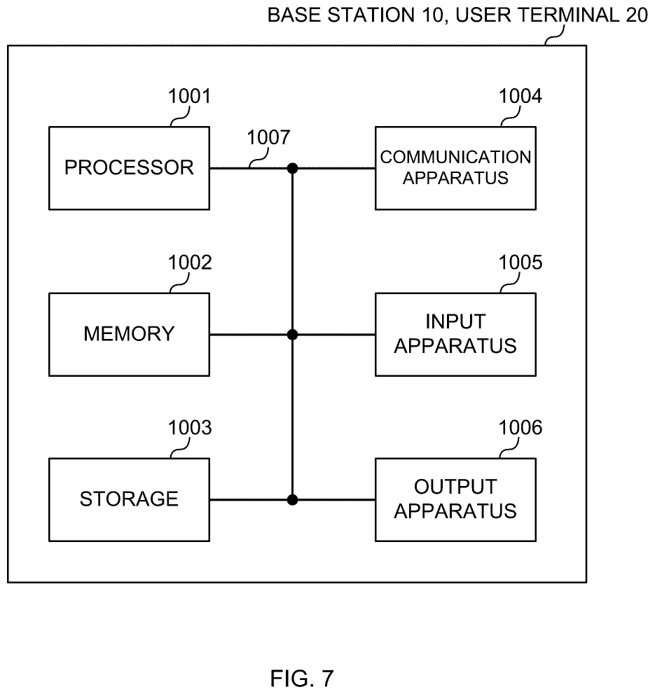

For example, a base station, a user terminal, and so on according to one embodiment of the present disclosure may function as a computer that executes the processes of the radio communication method of the present disclosure. FIG. 7 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAN), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted by using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmission power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not assume transmission/reception of a certain signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to certain values, or may be represented in another corresponding information. For example, radio resources may be specified by certain indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of certain information (for example, reporting of “X holds”) does not necessarily have to be reported explicitly, and can be reported implicitly (by, for example, not reporting this certain information or reporting another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on.

The moving object is a movable object with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

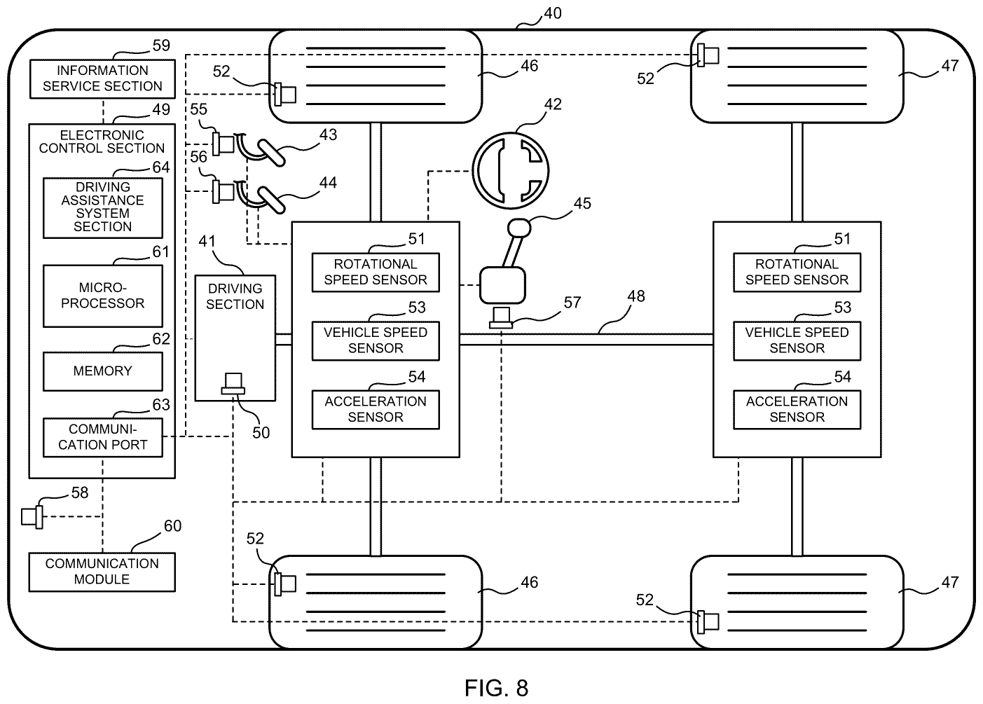

FIG. 8 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 at least includes a steering wheel, and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 included in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes various devices for providing (outputting) various pieces of information such as drive information, traffic information, and entertainment information, such as a car navigation system, an audio system, a speaker, a display, a television, and a radio, and one or more ECUs that control these devices. The information service section 59 provides various pieces of information/services (for example, multimedia information/multimedia service) for an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor, and one or more ECUs that control these devices. The driving assistance system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, via the communication port 63, the communication module 60 transmits and receives data (information) to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 can be controlled by the microprocessor 61 of the electronic control section 49, and is a communication device that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals from the various sensors 50 to 58 described above input to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the various pieces of information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may perform control of the driving section 41, the steering section 42, the accelerator pedal 43, the brake pedal 44, the shift lever 45, the right and left front wheels 46, the right and left rear wheels 47, the axle 48, the various sensors 50 to 58, and the like included in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (M4B), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods, next-generation systems that are enhanced, modified, created, or defined based on these, and the like. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

“The maximum transmit power” according to the present disclosure may mean a maximum value of the transmit power, may mean the nominal maximum transmit power (the nominal UE maximum transmit power), or may mean the rated maximum transmit power (the rated UE maximum transmit power).

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1.-6. (canceled)

7. A terminal comprising:
a transmitter that transmits a single UE capability information indicating support of sounding reference signal (SRS) antenna switching for six or more antennas; and
a processor that controls SRS transmission based on a configuration depending on the UE capability information,
wherein the UE capability information indicates support of only a part of downgrading configurations capable of being used by a UE-implemented antenna structure.

8. The terminal according to claim 7, wherein the UE capability information includes one or more SRS antenna switching patterns selected from among mandatory configurations and the downgrading configurations.

9. The terminal according to claim 7, wherein the UE capability information includes one or more SRS antenna switching patterns out of t1r1, t2r2, t1r2, t4r4, t2r4, t1r4, t2r6, t1r6, t4r8, t2r8, and t1r8.

10. A radio communication method for a terminal, comprising:
transmitting a single UE capability information indicating support of sounding reference signal (SRS) antenna switching for six or more antennas; and
controlling SRS transmission based on a configuration depending on the UE capability information,
wherein the UE capability information indicates support of only a part of downgrading configurations capable of being used by a UE-implemented antenna structure.

11. A base station comprising:
a receiver that receives a single UE capability information indicating that a terminal supports sounding reference signal (SRS) antenna switching for six or more antennas; and
a processor that performs a configuration related to SRS transmission, based on the UE capability information,
wherein the UE capability information indicates support of only a part of downgrading configurations capable of being used by a UE-implemented antenna structure.

12. A system comprising a terminal and a base station, wherein
the terminal comprises:
a transmitter that transmits a single UE capability information indicating support of sounding reference signal (SRS) antenna switching for six or more antennas; and
a processor that controls SRS transmission based on a configuration depending on the UE capability information, and
the base station comprises:
a receiver that receives the UE capability information; and
a processor that performs the configuration related to the SRS transmission,
wherein the UE capability information indicates support of only a part of downgrading configurations capable of being used by a UE-implemented antenna structure.
